(19) United States
(12) Patent Application Publication
(10) Pub. No.: US 2004/0052214 A1
(43) Pub. Date: Mar. 18, 2004

(54) System for routing data via the best communications link based on data size, type and urgency and priority

(76) Inventors: Jin Teik Teh, Los Altos, CA (US); Chang-Lin Lin, San Jose, CA (US)

Correspondence Address: Jason Z. Lin, Supreme Patent Services, Post Office Box 2339, Saratoga, CA, 95070-0339, US

(21) Appl. No.: 10/600,513

(22) Filed: Jun. 21, 2003

Related U.S. Application Data
(60) Provisional application No. 60/410,583, filed on Sep. 12, 2002.

(51) Int. Cl. H04L 12/56; H04L 12/26

(52) U.S. Cl. 370/238; 370/252; 370/400; 709/238; 709/223

(57) ABSTRACT

The present invention provides a method for delivering data over a cellular or electronic network using the most appropriate network protocol. The data is delivered using the cellular network dial up protocol, internet protocol, short messaging protocol or multi-media messaging protocol depending on the size of the data, the type of the data, the urgency of the data, the priority of the data and the type of client computing device. In this invention, a server or plurality of servers routes the data to the appropriate communication network and protocol. A client or plurality of clients receives the data. The client can be a phone, a personal digital assistant or portable computing device that has a communication link.

### FIELD OF THE INVENTION

This invention relates to a method for routing data over a cellular or electronic network, and more specially to a method for routing data via the best communications link based on data size, type and urgency and priority.

### BACKGROUND OF THE INVENTION

The electronic communication today is comprised of groups of networks each running independently. Networks build their own routing algorithm and exchange routing information among theses various different systems. Many routing decisions result from breaking ties or the enforcement of routing policy by the customers, who attempt to balance load across available capacity. The quest for software platform that is able to deliver rich interactive, device integrated wireless information and applications is still in progress.

Ideally, such a data routing system should enable carriers, hardware manufactures, application and content developers to deliver interactive content and applications to customers. Furthermore, it should provide client-server interactivity to major existing and next generation wire or wireless operating system, including PocketPC, SmartPhone, Symbian, Java, PalmOS, BREW, and more. In short, a data delivery software platform aims to make it possible for data and application to be delivered on demand across various devices in wire or wireless communication.

Among them, the first issue to be addressed, is a method for delivering data over a cellular or electronic network using the most appropriate network protocol. The data is delivered using the cellular network dial-up protocol, internet protocol, short messaging protocol or multi-media messaging protocol, depending on the size of the data, the type of the data, the urgency of the data and the type of client computing device. A server or plurality of servers routes the data to the appropriate communications networks and protocol. A client or plurality of clients receives the data. The client can be a phone, a personal digital assistant or portable computing device that has a communication link.

### SUMMARY OF THE INVENTION

The present invention provides a method for delivering data over a cellular or electronic network using the most appropriate network protocol. The data is delivered using the cellular network dial up protocol, internet protocol, short messaging protocol or multi-media messaging protocol, depending on the size of the data, the type of the data, the urgency of the data, the priority of the data and the type of client computing device. In this invention, a server or plurality of servers routes the data to the appropriate communication network and protocol. A client or plurality of clients receives the data. The client can be a phone, a personal digital assistant or portable computing device that has a communication link.

The present invention will become more obvious from the following description when taken in connection with the accompanying drawings which show, for purpose of illustration only, a preferred embodiment in accordance with the present invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a pictorial representation of an example for data sending from the platform server to the platform client of the present invention;

FIG. 2 shows an algorithm flow chart for data sending from the platform server to platform client that may be used in the present invention; and

FIG. 3 is a pictorial representation of an example for data sending from the platform client to the platform server of the present invention.

### DETAILED DESCRIPTION OF THE INVENTION

The present invention provides a method for delivering data over a cellular or electronic network using the most appropriate network protocol. The data is delivered using the cellular network dial up protocol, internet protocol, short messaging protocol or multi-media messaging protocol, depending on the size of the data, the type of the data, the urgency of the data, the priority of the data and the type of client computing device. The data routing in the system can be roughly divided into two types. The first one is the data routing from platform server to platform client, while the other one is the reverse data routing from platform client to platform server. The priority for sending data between the two platforms mainly depends on an appropriate protocol to decide which protocol can be used for delivering application or data.

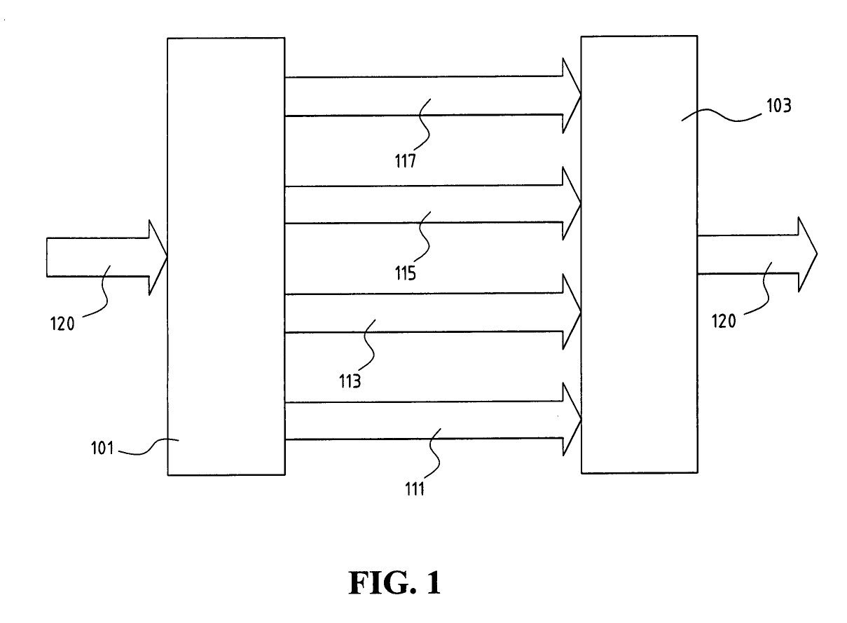

In this invention, as shown in FIG. 1, when sending data 120 from the platform server 101 to platform client 103, data 120 can be sent using the four optional protocols and networks: 1. Internet Protocol 113. 2. Dial up modem 111.3. short messaging service (SMS) 117. 4. multimedia messaging service (MMS) 115.

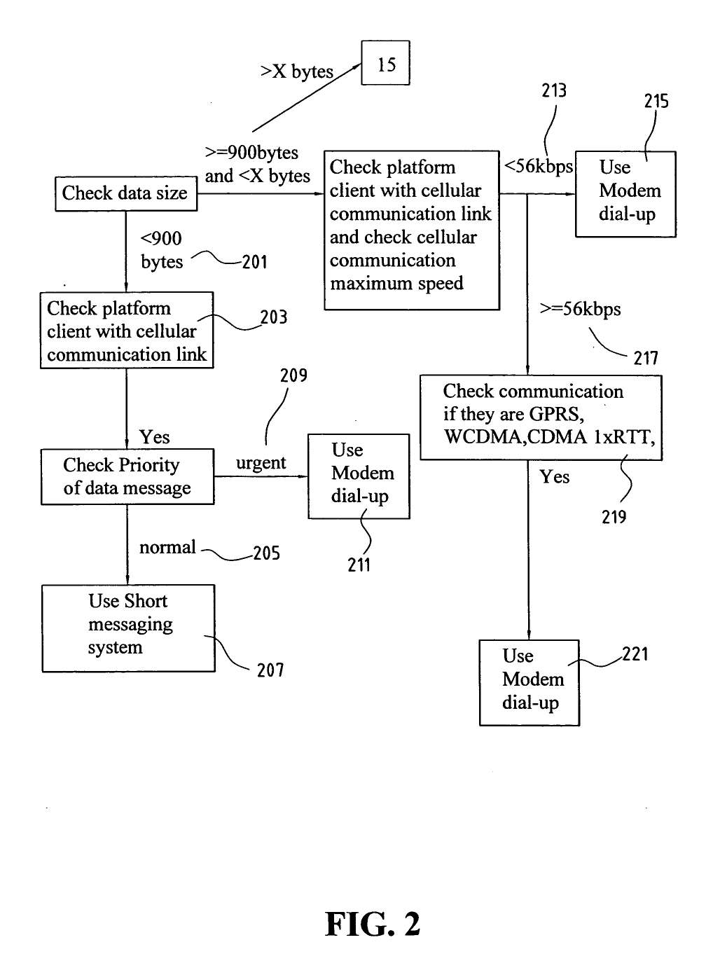

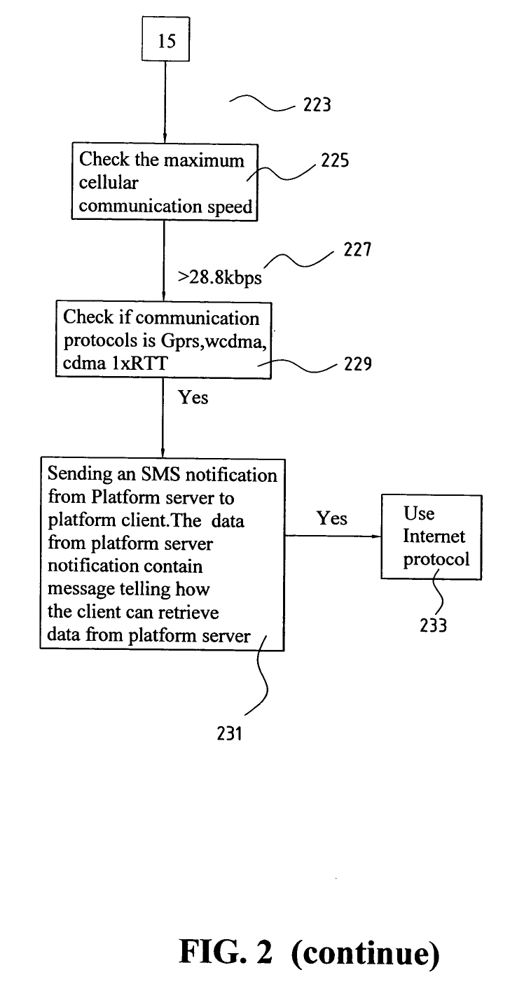

The platform server 101 decides which protocol to send data to the platform client 103. The routing algorithm determines the routing based on the data size, the transmission speed of the communication link, and the priority of the data, as shown in FIG. 2.

Step 201 is a step to determine the availability of a cellular communication link. If it exists, a further checking on the size of message data (step 203) is performed; otherwise, the server cannot push the sending of data to client. In this case, the client must poll for data (step 202). Step 203 determines the data size. If the size of the data is smaller than 900 bytes, and the priority of the message is urgent (step 204), the data is sent to the platform client via modem dial-up, as step 206 shows. If the priority of the message is normal, the message is sent to the client platform via short messaging system (SMS), as step 205.

If the size of the data is larger than 900 bytes, but less than X bytes, the algorithm performs step 207 to check the maximum speed of the cellular communication link. When the maximum speed is less than 56 kbps, the message is sent via modem dial up (step 208); otherwise, a further checking on the communication protocol is performed (step 209). If the communication protocol is either GPRS, WCDMA, or CDMA 1×RTT, the message is sent via modem dial-up (step 210); otherwise, step 211, the user polling step must be performed.

If the data size if larger than X bytes, the algorithm performs step 212 to check the maximum speed of the cellular communication link. When the maximum speed is no more than 28.8 kbps, the link is too slow for sending data. In this case, the user must use other suitable client to retrieve data; otherwise, a further checking on the communication protocol is performed (step 214). If the communication protocol is either GPRS, WCDMA, or CDMA 1×RTT, a notification message containing how to retrieve the full message is sent via short messaging system (step 216) to the client, otherwise, step 215 is performed. On receiving the notification message, the client uses a high-speed broadband connection, such as internet protocol, to retrieve the full message.

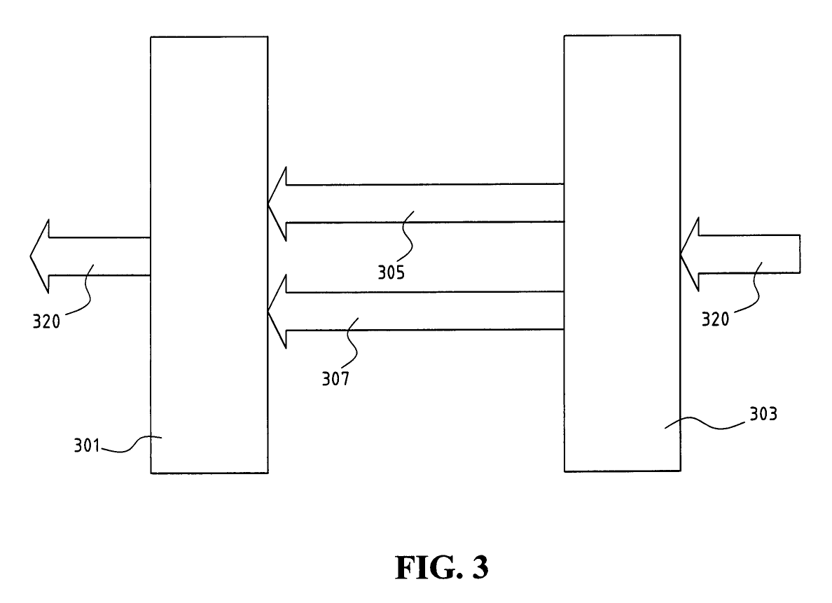

On the other hand, when sending data 320 from platform client 303 to platform server 301, data 320 can be sent either by Internet protocol 305 or Dial-up modem 307 as shown in FIG. 3. The platform server 301 decides which protocol to send data to the platform client 303. The routing algorithm is much simpler than the aforementioned protocols.

1. If the platform client 303 has a communication link that supports 2.5 generation or better cellular communication link, with GPRS, WCDMA, or CDMA 1×RTT or better, the platform client 303 uses Internet protocol 305 to send data to platform server 301.

2. If the platform client 301 does not have communications link that supports 2.5 generations or better cellular communication link, such as GPRS, WCDMA, or CDMA 1×RTT or better, the platform client 303 uses dial-up modem 307 to send data to the platform server 301.

While the preferred embodiment of the invention has been illustrated and described, it will be appreciated that various changes can be made therein without departing from the spirit and scope of the invention.

What is claimed is:

1. In a data communication network having a plurality of computer systems and using a plurality of communication protocols, a method for selecting the best routes for data communication comprising the following steps:
sending a data to and receiving the data from a platform server;
sending the data to and receiving the data from a platform client;
determining a protocol based on data characteristics; and
routing the data by the selected protocol to reach one or more destinations.

2. The method of data communication as claimed in claim 1, wherein the data is sent to the platform server and is received from the platform server by Dial up modem.

3. The method of data communication as claimed in claim 1, wherein the data is sent to the platform server and is received from the platform server by Internet Protocol.

4. The method of data communication as claimed in claim 1, wherein the data is sent to the platform server and is received from the platform server by Short Messaging Service (SMS).

5. The method of data communication as claimed in claim 1, wherein the data is sent to the platform server and is received from the platform server by Multimedia Messaging Service (MMS).

6. The method of data communication as claimed in claim 2, wherein the platform server further comprises:
a Hayes supported phone modem for connecting with the platform client, wherein the platform client transmits the data by dial-up modem.

7. The method of data communication as claimed in claim 2, wherein the platform server further comprises:
a Hayes supported cellular modem for connecting with the platform client, wherein the platform client transmits the data by dial-up modem.

8. The method of data communication as claimed in claim 3, wherein the platform server further comprises:
a communications link that supports the Internet Protocol for connecting with the platform client, wherein the platform client transmits the data by the Internet.

9. The method of data communication as claimed in claim 4, wherein the platform server further comprises:
a communication link which connects with Short Messaging Service (SMS) gateway for transmitting the data with the platform client.

10. The method of data communication as claimed in claim 5, wherein the platform server further comprises:
a communications link which connects with Multimedia Messaging Service (MMS) gateway for transmitting the data with the platform client.

11. The method of data communication as claimed in claim 1, wherein the determining a protocol step is based on:
size of the data;
maximum cellular communication link speed;
priority of the data; and
communication protocol.

12. The method of data communication as claimed in claim 2, wherein the determining a protocol step is based on:
size of the data;
maximum cellular communication link speed;
priority of the data; and
communication protocol.

13. The method of data communication as claimed in claim 3, wherein the determining a protocol step is based on:
size of the data;
maximum cellular communication link speed;
priority of the data; and
communication protocol.

14. The method of data communication as claimed in claim 4, wherein the determining a protocol step is based on:
size of the data;
maximum cellular communication link speed;
priority of the data; and
communication protocol.

15. The method of data communication as claimed in claim 5, wherein the determining a protocol step is based on:
size of the data;
maximum cellular communication link speed;
priority of the data; and
communication protocol.

16. The method of data communication as claimed in claim 6, wherein the determining a protocol step is based on:
size of the data;
maximum cellular communication link speed;
priority of the data; and
communication protocol.

17. The method of data communication as claimed in claim 7, wherein the determining a protocol step is based on:
size of the data;
maximum cellular communication link speed;
priority of the data; and
communication protocol.

18. The method of data communication as claimed in claim 8, wherein the determining a protocol step is based on:
size of the data;
maximum cellular communication link speed;
priority of the data; and
communication protocol.

19. The method of data communication as claimed in claim 9, wherein the determining a protocol step is based on:
size of the data;
maximum cellular communication link speed;
priority of the data; and
communication protocol.

20. The method of data communication as claimed in claim 10, wherein the determining a protocol step is based on:
size of the data;
maximum cellular communication link speed;
priority of the data; and
communication protocol.

21. The method of data communication as in claim 1, wherein the determining a protocol step further comprises a step of: if the destination is a client without a cellular communication link, the user must poll for data sending.

22. The method of data communication as in claim 2, wherein the determining a protocol step further comprises a step of: if the destination is a client without a cellular communication link, the user must poll for data sending.

23. The method of data communication as in claim 3, wherein the determining a protocol step further comprises a step of: if the destination is a client without a cellular communication link, the user must poll for data sending.

24. The method of data communication as in claim 4, wherein the determining a protocol step further comprises a step of: if the destination is a client without a cellular communication link, the user must poll for data sending.

25. The method of data communication as in claim 5, wherein the determining a protocol step further comprises a step of: if the destination is a client without a cellular communication link, the user must poll for data sending.

26. The method of data communication as in claim 6, wherein the determining a protocol step further comprises a step of: if the destination is a client without a cellular communication link, the user must poll for data sending.

27. The method of data communication as in claim 7, wherein the determining a protocol step further comprises a step of: if the destination is a client without a cellular communication link, the user must poll for data sending.

28. The method of data communication as in claim 8, wherein the determining a protocol step further comprises a step of: if the destination is a client without a cellular communication link, the user must poll for data sending.

29. The method of data communication as in claim 9, wherein the determining a protocol step further comprises a step of: if the destination is a client without a cellular communication link, the user must poll for data sending.

30. The method of data communication as in claim 10, wherein the determining a protocol step further comprises a step of: if the destination is a client without a cellular communication link, the user must poll for data sending.

31. The method of data communication as claimed in claim 1, wherein the determining a protocol step further comprises a step of: if the size of the data is smaller than 900 bytes, and the destination is a client with cellular communication link, and the priority on the message is normal, then the data is sent to the client via short message service (SMS) protocol.

32. The method of data communication as claimed in claim 2, wherein the determining a protocol step further comprises a step of: if the size of the data is smaller than 900 bytes, and the destination is a client with cellular communication link, and the priority on the message is normal, then the data is sent to the client via short message service (SMS) protocol.

33. The method of data communication as claimed in claim 3, wherein the determining a protocol step further comprises a step of: if the size of the data is smaller than 900 bytes, and the destination is a client with cellular communication link, and the priority on the message is normal, then the data is sent to the client via short message service (SMS) protocol.

34. The method of data communication as claimed in claim 4, wherein the determining a protocol step further comprises a step of: if the size of the data is smaller than 900 bytes, and the destination is a client with cellular communication link, and the priority on the message is normal, then the data is sent to the client via short message service (SMS) protocol.

35. The method of data communication as claimed in claim 5, wherein the determining a protocol step further comprises a step of: if the size of the data is smaller than 900 bytes, and the destination is a client with cellular communication link, and the priority on the message is normal, then the data is sent to the client via short message service (SMS) protocol.

36. The method of data communication as claimed in claim 6, wherein the determining a protocol step further comprises a step of: if the size of the data is smaller than 900 bytes, and the destination is a client with cellular communication link, and the priority on the message is normal, then the data is sent to the client via short message service (SMS) protocol.

37. The method of data communication as claimed in claim 7, wherein the determining a protocol step further comprises a step of: if the size of the data is smaller than 900 bytes, and the destination is a client with cellular communication link, and the priority on the message is normal, then the data is sent to the client via short message service (SMS) protocol.

38. The method of data communication as claimed in claim 8, wherein the determining a protocol step further comprises a step of: if the size of the data is smaller than 900 bytes, and the destination is a client with cellular communication link, and the priority on the message is normal, then the data is sent to the client via short message service (SMS) protocol.

39. The method of data communication as claimed in claim 9, wherein the determining a protocol step further comprises a step of: if the size of the data is smaller than 900 bytes, and the destination is a client with cellular communication link, and the priority on the message is normal, then the data is sent to the client via short message service (SMS) protocol.

40. The method of data communication as claimed in claim 10, wherein the determining a protocol step further comprises a step of: if the size of the data is smaller than 900 bytes, and the destination is a client with cellular communication link, and the priority on the message is normal, then the data is sent to the client via short message service (SMS) protocol.

41. The method of data communication as claimed in claim 1, wherein the determining a protocol step further comprises a step of: if the size of the data is smaller than 900 bytes, and the destination is a client with cellular communication link, and the priority on the message is urgent, then the data is sent to the client via modem dial-up.

42. The method of data communication as claimed in claim 2, wherein the determining a protocol step further comprises a step of: if the size of the data is smaller than 900 bytes, and the destination is a client with cellular communication link, and the priority on the message is urgent, then the data is sent to the client via modem dial-up.

43. The method of data communication as claimed in claim 3, wherein the determining a protocol step further comprises a step of: if the size of the data is smaller than 900 bytes, and the destination is a client with cellular communication link, and the priority on the message is urgent, then the data is sent to the client via modem dialup.

44. The method of data communication as claimed in claim 4, wherein the determining a protocol step further comprises a step of: if the size of the data is smaller than 900 bytes, and the destination is a client with cellular communication link, and the priority on the message is urgent, then the data is sent to the client via modem dialup.

45. The method of data communication as claimed in claim 5, wherein the determining a protocol step further comprises a step of: if the size of the data is smaller than 900 bytes, and the destination is a client with cellular communication link, and the priority on the message is urgent, then the data is sent to the client via modem dialup.

46. The method of data communication as claimed in claim 6, wherein the determining a protocol step further comprises a step of: if the size of the data is smaller than 900 bytes, and the destination is a client with cellular communication link, and the priority on the message is urgent, then the data is sent to the client via modem dialup.

47. The method of data communication as claimed in claim 7, wherein the determining a protocol step further comprises a step of: if the size of the data is smaller than 900 bytes, and the destination is a client with cellular communication link, and the priority on the message is urgent, then the data is sent to the client via modem dialup.

48. The method of data communication as claimed in claim 8, wherein the determining a protocol step further comprises a step of: if the size of the data is smaller than 900 bytes, and the destination is a client with cellular communication link, and the priority on the message is urgent, then the data is sent to the client via modem dialup.

49. The method of data communication as claimed in claim 9, wherein the determining a protocol step further comprises a step of: if the size of the data is smaller than 900 bytes, and the destination is a client with cellular communication link, and the priority on the message is urgent, then the data is sent to the client via modem dialup.

50. The method of data communication as claimed in claim 10, wherein the determining a protocol step further comprises a step of: if the size of the data is smaller than 900 bytes, and the destination is a client with cellular communication link, and the priority on the message is urgent, then the data is sent to the client via modem dialup.

51. The method of data communication as claimed in claim 1, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

52. The method of data communication as claimed in claim 2, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

53. The method of data communication as claimed in claim 3, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

54. The method of data communication as claimed in claim 4, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

55. The method of data communication as claimed in claim 5, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

56. The method of data communication as claimed in claim 6, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

57. The method of data communication as claimed in claim 7, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

58. The method of data communication as claimed in claim 8, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

59. The method of data communication as claimed in claim 9, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

60. The method of data communication as claimed in claim 10, wherein the determining a protocol step further comprises step of: if the size of the data is larger than 900 bytes but less than X bytes, and the destination is a client with cellular communication link, and the maximum cellular communications link speed is less than 56 Kbps, then the data is sent to the client via modem dialup.

61. The method of data communication as claimed in claim 1, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

62. The method of data communication as claimed in claim 2, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

63. The method of data communication as claimed in claim 3, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

64. The method of data communication as claimed in claim 4, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

65. The method of data communication as claimed in claim 5, wherein the determining a protocol step further comprises a step of: if the size of the data is larger than 900 bytes but less than X bytes, and the destination is a client with cellular communication link, and the maximum cellular communications link speed is no less than 56 Kbps then the communication protocols is GPRS, WCDMA or CDMA 1×RTT, the data is sent to the client via modem dialup; otherwise, the user must poll for data sending.

66. The method of data communication as claimed in claim 6, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

67. The method of data communication as claimed in claim 7, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

68. The method of data communication as claimed in claim 8, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

69. The method of data communication as claimed in claim 9, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

70. The method of data communication as claimed in claim 10, wherein the determining a protocol step further comprises a step of: if the size of the data is larger than 900 bytes but less than X bytes, and the destination is a client with cellular communication link, and the maximum cellular communications link speed is no less than 56 Kbps, then the communication protocols is GPRS, WCDMA or CDMA 1×RTT, the data is sent to the client via modem dialup; otherwise, the user must poll for data sending.

71. The method of data communication as claimed in claim 1, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

72. The method of data communication as claimed in claim 2, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

73. The method of data communication as claimed in claim 3, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

74. The method of data communication as claimed in claim 4, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

75. The method of data communication as claimed in claim 5, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

76. The method of data communication as claimed in claim 6, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

77. The method of data communication as claimed in claim 7, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

78. The method of data communication as claimed in claim 8, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

79. The method of data communication as claimed in claim 9, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

80. The method of data communication as claimed in claim 10, wherein the determining a protocol step further comprises a step of: if the size of the data is larger than X bytes, and the client has a cellular communications link, and the maximum cellular communications link speed is no more than 28.8 Kbps, then data cannot be sent as the link is too slow; otherwise, when the maximum cellular communications link speed is more than 28.8 Kbps and the communication protocols is GPRS, WCDMA or CDMA 1×RTT, then an SMS notification message is sent to the client wherein the SMS message contains information on how the platform client can retrieve the data; otherwise, the user must poll for data sending.

81. The method of data communication as claimed in claim 1, wherein when the user receives the SMS notification message, the user can use other high-speed broadband connection to retrieve the data.

82. The method of data communication as claimed in claim 2, wherein when the user receives the SMS notification message, the user can use other high-speed broadband connection to retrieve the data.

83. The method of data communication as claimed in claim 3, wherein when the user receives the SMS notification message, the user can use other high-speed broadband connection to retrieve the data.

84. The method of data communication as claimed in claim 4, wherein when the user receives the SMS notification message, the user can use other high-speed broadband connection to retrieve the data.

85. The method of data communication as claimed in claim 5, wherein when the user receives the SMS notification message, the user can use other high-speed broadband connection to retrieve the data.

86. The method of data communication as claimed in claim 6, wherein when the user receives the SMS notification message, the user can use other high-speed broadband connection to retrieve the data.

87. The method of data communication as claimed in claim 7, wherein when the user receives the SMS notification message, the user can use other high-speed broadband connection to retrieve the data.

88. The method of data communication as claimed in claim 8, wherein when the user receives the SMS notification message, the user can use other high-speed broadband connection to retrieve the data.

89. The method of data communication as claimed in claim 9, wherein when the user receives the SMS notification message, the user can use other high-speed broadband connection to retrieve the data.

90. The method of data communication as claimed in claim 10, wherein when the user receives the SMS notification message, the user can use other high-speed broadband connection to retrieve the data.

91. An apparatus for selecting the best routes and protocols for data communication, the apparatus comprising:
a memory to store a program, and
a processor responsive to the program to:
(1). send data to and receive data from a platform server;
(2). send data to and receive data from a platform client;
(3). determine the best protocol based on data characteristics; and
(4). route data by the selected protocol to reach one or more destinations.

92. The apparatus as claimed in claim 91, wherein the data characteristic further comprises:
the size of the data;
the maximum cellular communication link speed;
the priority of the data; and
the communication protocol.

93. The apparatus as claimed in claim 91, wherein the memory is a hard disk.
